(19) United States
(12) Patent Application Publication
(10) Pub. No.: US 2011/0320446 A1
(43) Pub. Date: Dec. 29, 2011

(54) Pushing Search Query Constraints Into Information Retrieval Processing

(75) Inventors: Kaushik Chakrabarti, Redmond, WA (US); Surajit Chaudhuri, Redmond, WA (US); Venkatesh Ganti, Mountain View, CA (US)

(73) Assignee: MICROSOFT CORPORATION, Redmond, WA (US)

(21) Appl. No.: 12/823,124

(22) Filed: Jun. 25, 2010

(51) Int. Cl. G06F 17/30

(52) U.S. Cl. 707/737; 707/769; 707/E17.014; 707/E17.089

(57) ABSTRACT

This patent application relates to interval-based information retrieval (IR) search techniques for efficiently and correctly answering keyword search queries. In some embodiments, a range of information-containing blocks for a search query can be identified. Each of these blocks, and thus the range, can include document identifiers that identify individual corresponding documents that contain a term found in the search query. From the range, a subrange(s) having a smaller number of blocks than the range can be selected. This can be accomplished without decompressing the blocks by partitioning the range into intervals and evaluating the intervals. The smaller number of blocks in the subranges(s) can then be decompressed and processed to identify a doc ID(s) and thus document(s) that satisfies the query.

### BACKGROUND

Information retrieval (IR) can be computationally expensive. For example, IR search engines for answering top-k keyword search queries typically use document-at-a-time (DAAT) algorithms to search collections over the Web or other sources to identify top ranking documents to return as search results. These types of algorithms are associated with various IR computing costs, such as disk access costs, block decompression costs, and merge and score computation costs. Current IR techniques are limited in their ability to mitigate these costs while providing correct search results.

### SUMMARY

Interval-based IR search techniques are described for efficiently and correctly answering keyword search queries, such as top-k queries. These techniques can leverage keyword searching by “pushing” search query constraints down into an IR engine to avoid unnecessary computing costs. More particularly, a search query's terms (e.g., keyword(s)) and constraints (e.g., a designated top number (k) of results to be returned in an answer) can be utilized by the IR engine to reduce the number of compressed blocks that need to be decompressed in order to answer the search query. Since less compressed blocks need to be decompressed by the IR engine, decompression-related computing costs that might otherwise be incurred by the IR engine to answer the search query can be avoided. Furthermore, much smaller portions of lists can be merged and scores can be computed for fewer documents, thus drastically reducing merge and score computation costs.

In some embodiments, in response to receiving a search query, a range of compressed information-containing blocks can be identified. Each of these blocks can include individual document identifiers (doc IDs) that identify individual corresponding documents that contain a term found in the search query. From the identified range of blocks, one or more subranges of blocks having a smaller number of blocks than the entire identified range can be selected. Selecting the subrange(s) can include partitioning the identified range of blocks into intervals (that span individual corresponding blocks in the range) and then pruning one or more of the intervals (and thus corresponding blocks of the pruned interval(s)) based on the search query's terms and constraints. This can be accomplished without decompressing any blocks in the range. The smaller number of blocks in the subrange(s), rather than all the blocks in the range, can then be decompressed and processed to answer the search query. More particularly, to answer the search query, the smaller number of blocks can be decompressed and processed by an algorithm (e.g., a DAAT algorithm) to identify one or more doc IDs (and thus one or more documents) that satisfy the search query's terms and constraints.

In some embodiments, the intervals of the identified range can be pruned by evaluating the intervals to determine whether individual intervals are to be pruned (i.e., are prunable) or are not to be pruned (i.e., are non-prunable). More particularly, a score attributed to each interval can be compared to a threshold score that represents a minimum doc ID score that an interval should have in order to be non-prunable. Prunable intervals can then be pruned while non-prunable intervals can be processed. This processing can include reading, decompressing, and processing individual blocks overlapping the non-prunable intervals using the algorithm.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements.

FIG. 1 illustrates an example system in which the described Interval-based IR search techniques can be implemented, in accordance with some embodiments.

FIG. 2 illustrates an example IR engine, in accordance with some embodiments.

FIG. 3 illustrates example posting lists, in accordance with some embodiments.

FIG. 4 illustrates an example range for a search query, in accordance with some embodiments.

FIG. 5 illustrates an example operating environment, in accordance with some embodiments.

FIGS. 6 and 7 show example methods, in accordance with some embodiments.

### DETAILED DESCRIPTION

### Overview

This patent application relates to interval-based information retrieval (IR) search techniques for efficiently and correctly answering keyword search queries (e.g., top-k queries). These techniques can significantly mitigate the computing cost (hereinafter “cost”) typically incurred by IR engines when providing search results. More particularly, a search query's terms (e.g., keyword(s)) and constraints (e.g., a designated top number (k) of results to be returned in an answer) can be utilized by the IR engine to reduce the number of compressed blocks that need to be decompressed in order to answer the query. Since less compressed blocks need to be decompressed by the IR engine, decompression-related computing costs that might otherwise be incurred by the IR engine to answer the search query can be avoided. Furthermore, much smaller portions of lists can be merged and scores can be computed for fewer documents, thus drastically reducing merge and score computation costs.

To assist the reader in understanding the techniques described herein, a brief overview of IR engines and IR searching will first be provided. Typically, IR engines are used to support keyword searches over a document collection. One of the most popular types of keyword searches are so called “top-k” keyword searches. With top-k searches, a user can specify one or more search terms and a top number (“k”) of relevant documents to be returned in response. Optionally, one or more boolean expressions (e.g., “AND”, “OR”, etc.) can also be specified or otherwise included in such searches.

To support keyword searching of a document collection, an IR engine can build and maintain an inverted index on the document collection. The inverted index can store document identifiers (doc IDs) for each term found in the document collection. Each doc ID can identify a document in the document collection that contains that term.

Individual doc IDs can be associated with a corresponding payload. A payload for a doc ID can include a term score (e.g., a term frequency score (TFScore)) for the doc ID with respect to a particular term. More particularly, the term score can be a weighted score assigned to the doc ID that is based on the number of occurrences of the particular term in the doc ID's corresponding document.

A doc ID and its corresponding payload can be referred to as a posting. Individual postings for a particular term found in the document collection can be organized in one or more blocks that may be compressed. Each of these compressed blocks can include individual document identifiers (doc IDs) that identify individual corresponding documents. For discussion purposes, a compressed block(s) may be referred to herein as a block(s), while a block(s) that has been decompressed will be referred to herein as decompressed block(s). Individual blocks may be decompressed independently and may include a number of consecutive postings. In some embodiments, each of the blocks can have approximately the same number of postings (e.g., approximately 100).

Blocks for a particular term can belong to a posting list for that particular term, and can be stored on disk in doc ID order. Posting lists, in turn, can be stored contiguously on disk. The inverted index built and maintained by the document collection can include numerous contiguously stored posting lists, where individual posting lists correspond to a term found in the document collection.

In some embodiments, by utilizing the techniques described herein, summary data for each block in a posting list can be computed and stored in a metadata section of each posting list that is separate from the blocks in that posting list. As a result, by virtue of being stored in the metadata section, the summary data can be accessed/read without having to decompress the blocks in the posting list.

The summary data for each block can include the minimum doc ID in that block, the maximum doc ID in that block, and a highest term score (i.e., maximum term score) attributed to a doc ID found in that block. As explained in further detail below, a term score of any doc ID for a particular term can be calculated based on the frequency of the term in the document (referred to as term frequency) and an inverse document frequency score (IDFScore) for the particular term.

With respect to IR searching, in response to receiving a search query expression with one or more search terms, the IR engine can be configured to identify a range of blocks for the search query. This range of blocks can include individual doc IDs for documents containing the one or more search terms. More particularly, for each search term, a corresponding posting list for that search term can be identified in the inverted index. Each identified posting list can correspond to one of the search terms and can include postings organized and stored in blocks. The doc ID span of these postings can be identified as the range of doc IDs—and thus the range of blocks.

By utilizing summary data stored in posting lists, one or more subranges of blocks to be processed can be selected from the range. For example, in some embodiments, the subrange(s) of blocks can be selected by partitioning blocks in the range into intervals and evaluating each interval to determine whether the interval is prunable (i.e. to be pruned) or non-prunable (i.e., not to be pruned). Blocks overlapping a non-prunable interval(s) can then be selected to be read, decompressed, and processed (using an algorithm) to identify one or more doc IDs, and thus one or more corresponding documents, that satisfy the query. On the other hand, compressed blocks overlapping a prunable interval, but not overlapping a non-prunable interval, can be ignored.

Multiple and varied implementations are described below. Generally, any of the features/functions described with reference to the figures can be implemented using software, hardware, firmware (e.g., fixed logic circuitry), manual processing, or any combination thereof.

The term, “module” or “component” as used herein generally represents software, hardware, firmware, or any combination thereof. For instance, the term “module” or “component” can represent software code and/or other types of instructions that perform specified tasks when executed on a computing device or devices.

Generally, the illustrated separation of modules, components, and functionality into distinct units may reflect an actual physical grouping and allocation of such software, firmware, and/or hardware. Alternatively or additionally, this illustrated separation can correspond to a conceptual allocation of different tasks to the software, firmware, and/or hardware. Furthermore, it is to be appreciated and understood that the illustrated modules, components, and functionality described herein can be located at a single site (e.g., as implemented by a computing device), or can be distributed over multiple locations (e.g., as implemented by multiple computing devices).

### EXAMPLE SYSTEM

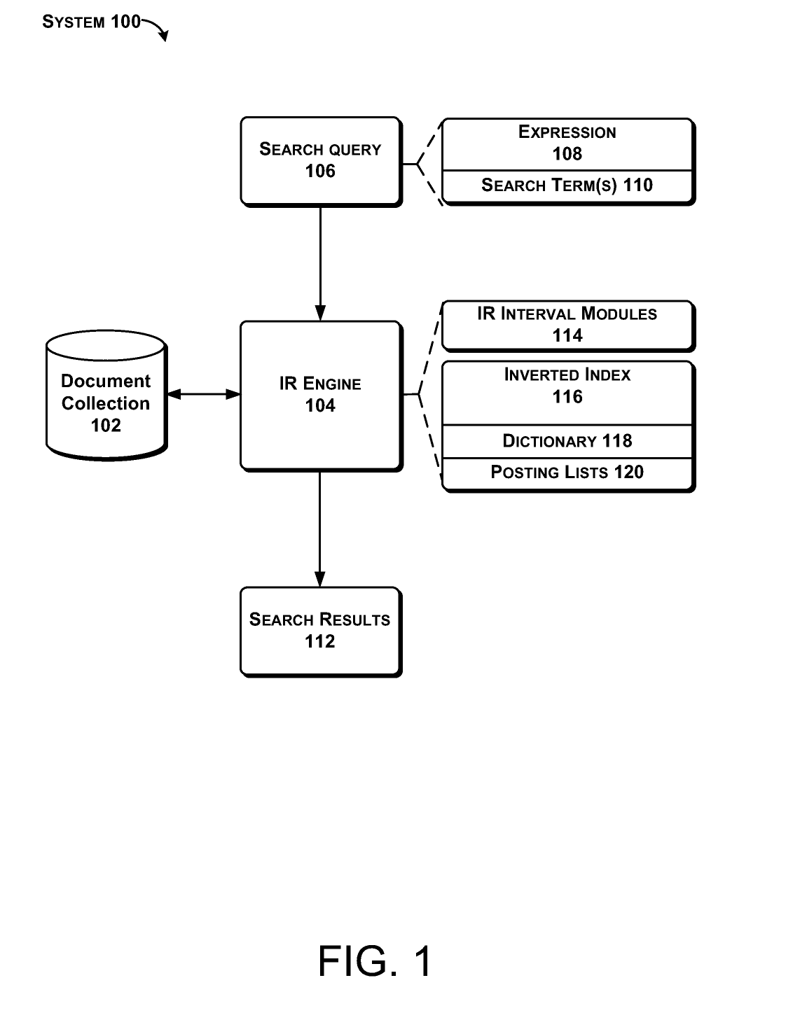

FIG. 1 illustrates an example system, generally at 100, in which the described interval-based IR search techniques can be implemented. The system 100 includes a document collection 102 which can include any number of documents found over any number of a variety of possible sources. Without limitation, these sources can include the Internet (e.g., a Web source(s)), an enterprise document source(s), a domain-specific document repository, and the like.

The system 100 also includes an IR engine 104 configured to support keyword searching over the document collection 102 utilizing the described interval-based IR search techniques. In this example, the IR engine 104 is shown as receiving a search query 106 which may contain a search query expression 108 that includes one or more search terms (e.g., words) 110. The expression 108 can also include a top-k constraint and one or more Boolean expressions that describe the term(s) 110 and that influence how the search query 106 is to be answered by the IR engine 104.

Here, an answer to the search query 106 is shown as search results 112. The search results 112 may include one or more documents of the document collection 102 and/or references to document(s) (e.g., doc IDs) identified by the IR engine 104 as satisfying the expression 108. For example, the search query 106 may be a top-k search query that indicates that a certain number (k) of the most relevant (e.g., highest scoring) documents are desired in the search results 112.

To facilitate providing the search results 112, the IR engine 104 can be configured with IR interval modules 114. In addition, the IR engine 104 can be configured to build and maintain an inverted index 116 on the document collection 102 to facilitate IR searching. In some embodiments, functionality provided by the IR interval modules 114 can be utilized to help build and/or maintain the inverted index 116.

The inverted index 116, in turn, can be configured with a dictionary 118 for storing distinct terms found in the document collection 102 and with posting lists 120. The posting lists 120 can include individual postings corresponding to various terms found in the document collection 102. Each of the search term(s) 110 can be matched to a corresponding individual posting list of the posting lists 120.

As described above, summary data can be utilized according to the described interval-based IR search techniques to efficiently and correctly answer the search query 106. More particularly, individual posting lists corresponding to each of the search term(s) 110 can be identified from the posting lists 120. Based on the collective individual doc IDs of these individual posting lists, a range (hereinafter “the range”) of doc IDs—and thus blocks—can be identified for the search query 106. Identifying the range can be performed by any suitable module or component of, or associated with, the IR engine 104. For example, the IR engine 104 may be configured with a range module for accomplishing the identifying. Alternatively or additionally, one of the IR interval modules 114 may be configured to identify the range.

### Example IR Engine

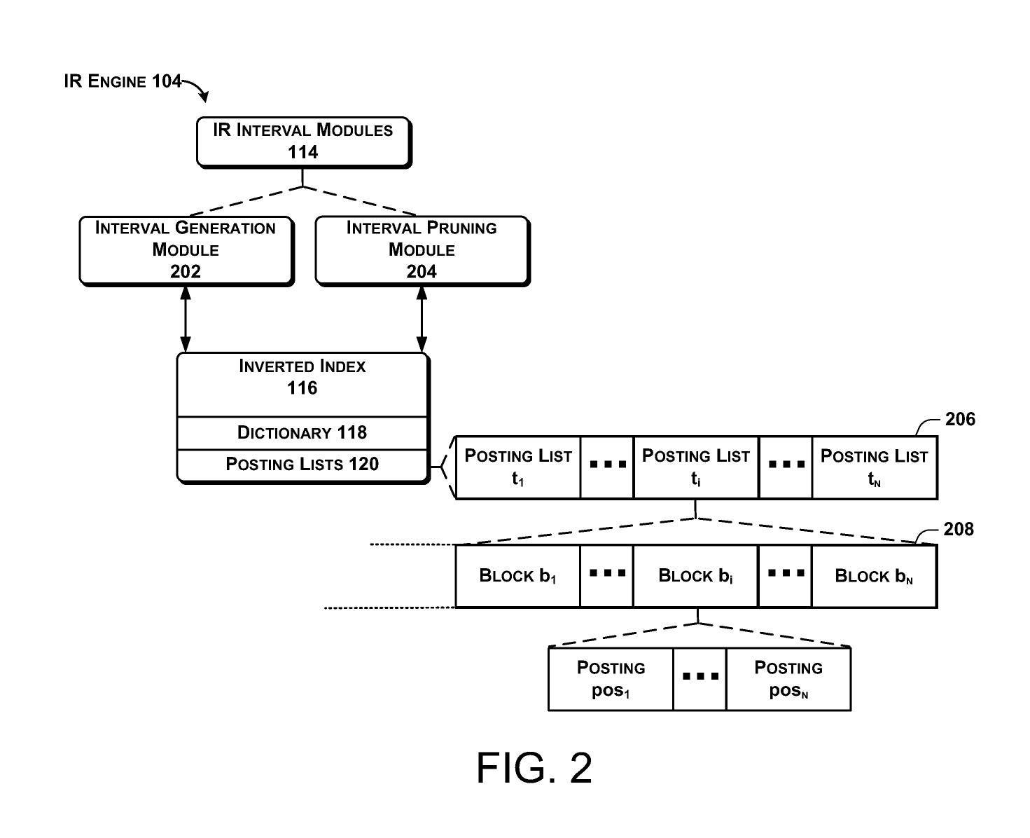

To assist the reader in understanding the described interval-based IR search techniques, FIG. 2 illustrates further details of the IR engine 104. While like numerals from FIG. 1 have been utilized to depict like components, FIG. 2 illustrates but one example of an IR engine and is thus not to be interpreted as limiting the scope of the claimed subject matter.

In this example, the IR interval modules 114 include an interval generation module 202 and an interval pruning module 204. These modules can be configured to read from and write to the inverted index 116. In some embodiments, this can be accomplished via one or more application program interfaces (APIs) of the inverted index 116. Each of these modules is described generally just below and then described in more detail later.

With respect to the interval generator module 202, this module can be configured to retrieve the summary data described above. More particularly, recall that the summary data can be stored in, and thus retrieved from, the metadata sections of individual posting lists corresponding to blocks of the range. The summary data can be retrieved from a posting list by the interval generator module 202 without having to decompress any of the posting list's blocks. In some embodiments, a particular metadata reading API of the inverted index 116 can be utilized by the interval generator module 202 to retrieve the summary data.

The interval generator module 202 can also be configured to partition the range into intervals. The interval generator module 202 can accomplish this by using the summary data and the search term(s) 110 to generate intervals of the range and then to compute upper-bound (ub) interval scores for each interval. For example, the interval generator module 202 can use minimum doc ID information, maximum doc ID information, and maximum term score information in the summary data to define, for each of the terms 110, individual portions of the range that overlap with one block or one gap of the range.

The interval pruning module 204, in turn, can be configured to evaluate the generated intervals based on their respective ub interval scores to determine whether they are prunable (i.e. to be pruned) or non-prunable (i.e., not to be pruned). More particularly, each interval's respective ub interval score can be compared to a threshold score to determine whether or not the interval can contribute at least one doc ID to the search results 112. If the interval can contribute at least one doc ID, then it can be considered non-prunable. If the interval cannot contribute at least one doc ID, then it can be considered prunable.

In some embodiments, the interval pruning module 204 can also be configured to prune prunable intervals and to process non-prunable intervals. More particularly, blocks overlapping a prunable interval but not overlapping a non-prunable interval can be ignored, thus effectively pruning the prunable interval. In this way, costs that might otherwise be incurred by processing these blocks can be avoided. Blocks overlapping non-prunable intervals, on the other hand, can be processed. This processing can include reading, decompressing, and processing (e.g., by using a DAAT algorithm) these blocks.

### Posting Lists

Before describing the interval generator module 202 and the interval pruning module 204 in further detail, an example organizational structure of the posting lists 120 will be described to assist the reader in understanding the more detailed discussion thereafter.

Recall that each of the search term(s) 110 can be matched to a corresponding posting list from the posting lists 120. For discussion purposes assume that the search term(s) 110 consists of search terms: q₁-q_{N} (including qᵢ). The posting lists 206 can thus include a corresponding number of posting lists: t₁-t_{N} (including posting list tᵢ). Since posting lists t₁ . . . tᵢ . . . t_{N} correspond to search terms q₁ . . . qᵢ . . . q_{N} respectively, the range can be thought of as being defined by the individual doc IDs of these posting lists.

Taking posting list tᵢ as an example posting list, note that a detailed view of a block section of posting list tᵢ is labeled in FIG. 2 as the block section 208. For discussion purposes, a block section of a posting list can be thought of as a portion of the posting list in which blocks can be stored. In this example, the block section 208 includes, among other elements, a series of contiguous blocks that are compressed: block b₁-block b_{N} (including block bᵢ), each of which may be decompressed independently. In some embodiments, each of these blocks can contain a similar number of individual postings (e.g., approximately 100). Summary data for each of these blocks can be computed based on the payloads of their corresponding doc ID postings. This computing can be performed by any suitable module or component, such as by a summary data module and/or one of the IR interval modules 114 for instance.

Taking block bᵢ as an example posting list block, note that, block bᵢ includes a number of compressed individual postings: postings pos₁-pos_{N}. These postings can be consecutively stored according to doc ID order in block bᵢ. Storing postings in doc ID order can facilitate compression of d-gaps (differences between consecutive doc IDs) and insertion of new doc IDs into posting lists when new documents are added to the document collection 102. In addition, storing postings in doc ID order can also help mitigate costs associated with processing search queries (e.g., Boolean queries), such as the search query 106.

Furthermore, individual term scores of the payloads for postings pos₁pos_{N} can be used to compute the following summary data for block bᵢ: the minimum doc ID found in block bᵢ, the maximum doc ID found in block bᵢ, and the maximum (i.e, highest) term score found in block bᵢ. As noted above, individual doc ID scores can be calculated for, and attributed to, each doc ID based on the term score for a particular term in that doc ID's payload and an IDFScore for the particular term. For example, in some embodiments the overall doc ID score of a document can be thought of as a textual score denoted as Score(d, q, D) and computed as:

Score(d,q,D)=⊕_{tεq∩d}TFScore(d, t, D)×IDFScore(t, D)

where TFScore(d,t,D) is an example of a term score, ⊕ is a monotone function which takes a vector of non-negative real numbers and returns a non-negative real number, d is a particular document, q is a particular query, t is a particular term, and D is a particular document collection that contains d.

Since the postings of block bᵢ are stored in doc ID order, the minimum doc ID in block bᵢ can be considered block bᵢ's startpoint in the range. Similarly, the maximum doc in block bᵢ can be considered block bᵢ's endpoint in the range. Furthermore, the maximum term score in block bᵢ can be considered block bᵢ's ub block score. As mentioned briefly above and explained in further detail below, summary data for individual blocks in the range can be used by the interval generator module 202 to partition the range into intervals and to compute ub interval scores for each interval.

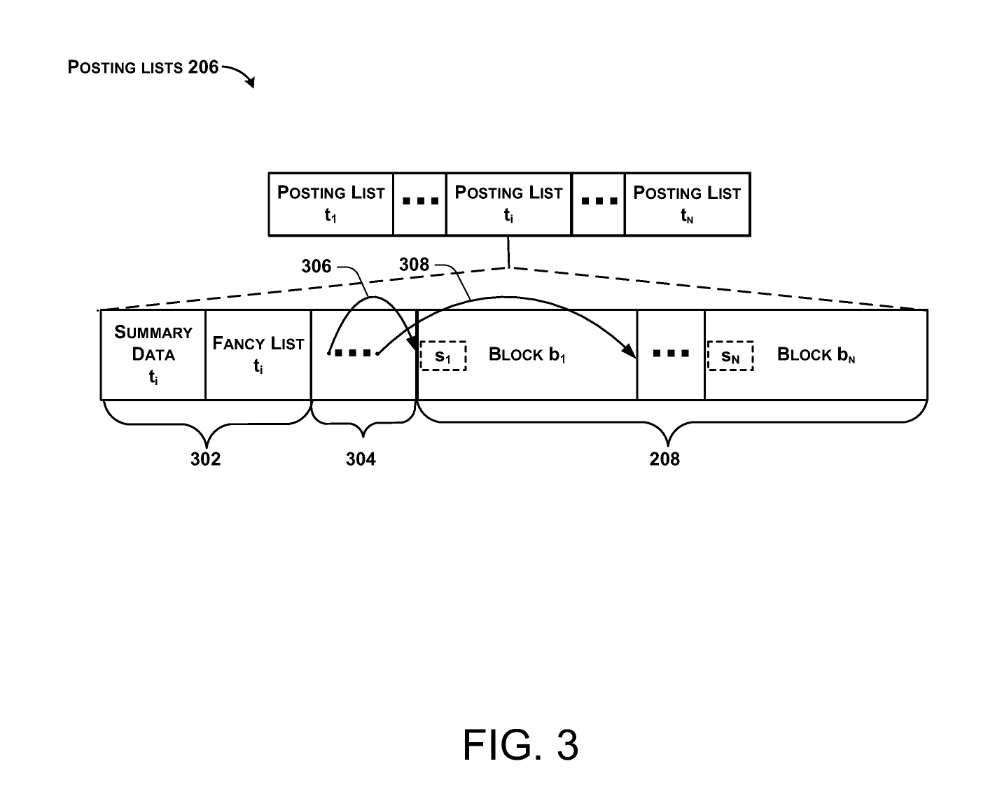

To further assist the reader in understanding the organizational structure of posting lists, FIG. 3 illustrates further details of example posting list tᵢ. While like numerals from FIGS. 1 and 2 have been utilized to depict like components, FIG. 3 illustrates but one example of a posting list and is thus not to be interpreted as limiting the scope of the claimed subject matter.

As described briefly above, example posting list tᵢ includes the block section 208 with contiguous blocks b₁-b_{N} (including block bᵢ). The block section 208 may also optionally include individual signatures s₁-s_{N} for each of blocks b₁-b_{N}, respectively. As described in further detail below, in some embodiments these signatures can be used to help identify and avoid processing certain intervals.

In this example, posting list tᵢ also includes a metadata section 302 for storing summary data tᵢ. Summary data tᵢ can include contiguously stored summary data for each of blocks b₁-b_{N}. Since summary data tᵢ can be stored apart from the block section 208, it can be retrieved or otherwise accessed without blocks b₁-b_{N} in the block section 208 having to be decompressed. Decompression-related costs that might otherwise be associated with obtaining summary data from the blocks can be avoided. Storing the summary data can be performed by any suitable module or component. For example, the summary data module mentioned above may be used, and/or one of the IR interval modules 114 may be used.

Metadata section 302 may optionally include a listing of a small percentage (e.g., approximately 1%) of the doc IDs of blocks b₁-b_{N} having the highest relative term scores. This listing may be referred to as a “fancy list”. As will be described in further detail below, in some embodiments, doc IDs listed in a fancy list can be excluded from blocks b₁-b_{N} and treated separately to “tighten” ub interval scores.

Example posting list tᵢ may also optionally include an array of pointers (e.g., disk addresses) that can be maintained by the IR engine 104. In some embodiments, such as illustrated here, the array of pointers can be stored in an array section 304 at or near the beginning of posting list tᵢ. Alternatively or additionally, one or more individual pointers can be interleaved with individual corresponding blocks of the block section 208. Each of these pointers may point to the start of a corresponding individual block of the block section 208. Here, this is illustrated by pointers 306 and 308 pointing to blocks b₁ and b_{N} respectively. As will be appreciated and understood by those skilled in the art, such an array can facilitate certain algorithms performing random access of blocks b₁-b_{N}.

### Example Range

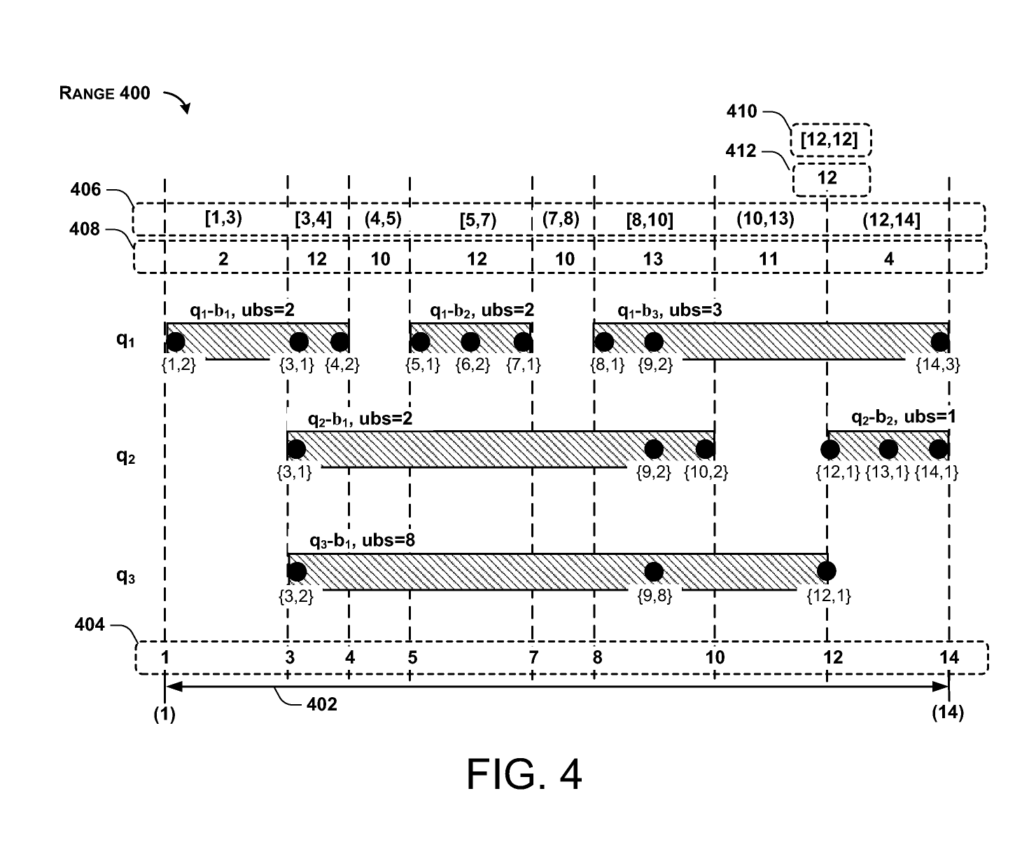

To facilitate the reader in understanding details associated with the operations of IR interval modules 114, FIG. 4 illustrates one example or iteration of the above-described range, designated here as a range 400. While like numerals from FIGS. 1-3 have been utilized to depict like components, FIG. 4 illustrates but one example of a doc ID/block range and is thus not to be interpreted as limiting the scope of the claimed subject matter.

For the sake of discussion, assume in this example that the search term(s) 110 of the expression 108 consists of three distinct search terms: q₁, q₂, and q₃. Also assume that the posting lists 120 include three posting lists (not shown) corresponding to each of these search terms. Further, assume that each of the blocks in the range 400 includes three postings, ranging from a doc ID of (1) to a doc ID of (14). Therefore, the range 400 can be thought of as being defined by a range span 402 of (1)-(14).

Here, each block of the range 400 is shown relative to the doc ID range span 402 (horizontal axis) and the block's corresponding search term (vertical axis). Additionally, each block is also denoted by its order relative to other blocks corresponding to the same search term, and by its corresponding ub block score (ubs). For example, the first block (from the left) of search term q₁ is denoted by the tuple: q₁-b₁, ubs=2.

Each posting, in turn, is shown relative to a corresponding block. Additionally, each posting is denoted by a respective doc ID and term score. For example, the first posting of block q₁-b₁, ubs=2 is denoted by “{1 ,2}”, where “1” designates the first posting's doc ID and “2” that doc ID's corresponding term score. In this regard, assuming the doc ID score of this posting can be calculated as: ⊕_{tεq∩d} term score×IDFScore, and assuming an IDFScore of 1, the doc ID score of this first posting will be 2.

With respect to the intervals of the range 400, recall that the interval generator module 202 can use summary data retrieved from individual blocks to partition the range into intervals. In operation, in some embodiments the interval generator module 202 can accomplish this by generating intervals with interval boundaries according to the following definition:

### Example Definition 1 (Interval)

an interval can be defined as a maximal subrange of a range that overlaps with the span of exactly one block or one gap for each search term.

Based on example definition 1 (Interval), regardless of the number of search terms in a search query, an individual interval can be thought of as spanning exactly one block and/or exactly one gap between two blocks for each term. The range 400 is thus shown as partitioned into nine intervals with interval boundaries 404 indicated here by vertical dashed lines. Each of the interval boundaries 404 are denoted by a corresponding boundary point in the doc ID range span 402. As shown, each boundary point corresponds to a startpoint and/or endpoint of a block spanning an interval defined by that boundary point and one other boundary point. For example, the first interval boundary point (from the left) of the doc ID range 402 is denoted by “1”, which is the startpoint of block q₁-b₁, ubs=2.

Also recall that the interval generator module 202 can be configured to use summary data to compute ub interval scores for each generated interval. In embodiments where intervals are defined according to example definition 1 (interval) above, the property that an individual interval overlaps with exactly one block or gap per search term can be leveraged to compute ub interval scores. More particularly, in operation, the interval generator module 202 can compute individual ub interval scores according to the following example definition and lemma:

### Example Definition 2 (ub Interval Score)

considering a query with search terms {q₁, . . . ,qₙ}. ν.ubscore[i] of an interval ν can be defined as follows:

=ub block score of b if ν overlaps with block b for term qᵢ

=0 if ν overlaps with gap for query term qᵢ

The ubscore ν.ubscore[i] of the interval ν is

⊕ᵢ ν.ubscore[i]×IDFScore (qᵢ, D)

wherein IDFScore (qᵢ, D) denotes the IDFScore of query term qᵢ for a document collection D.

### Example Lemma 1: (ub Interval Score)

The ub interval score “ubscore” of an interval upper bounds the doc ID scores of the doc IDs contained in the interval.

Here, each of the nine intervals are thus denoted according to their span of the doc ID range span 402. More particularly, the interval spans of eight of the nine intervals are shown at 406. Each of the eight intervals shown at 406 include a first boundary point and a second different boundary point which, together, designate each interval's span of the doc ID range span 402. For example, the first interval (from the left) is denoted by the interval span [1,3). Furthermore, a ub interval score corresponding to each of the eight intervals is shown at 408. For example, the first interval [1,3) is shown as having an interval score of “2”.

Similarly, the interval span of the ninth interval is shown at 410. Unlike the other eight intervals, this interval is designated by the interval span [12,12] because different blocks of the range 400 (namely: q₃-b₁, ubs=8 and q₂-b₂, ubs=1) start and end at the same boundary point, namely boundary point 12. This interval can thus be thought of as having the interval span [12,12]. Such an interval may be referred to as a “Singleton interval”. The ub interval score “12” corresponding to this Singleton interval is shown at 412.

Note that with respect to denoting the individual interval spans (shown at 406 and 410), individual spans may be closed, open, left-closed-right-open or left-open-right-closed (denoted by [], ( ) [) and (] respectively). For example, the span of the first interval [1,3) is left-closed (i.e., includes boundary point 1) but right-open (i.e., excludes boundary point 3). The only block overlapping this interval is q₁-b₁, ubs=2. Furthermore, given example definition 2 (ub interval score) and lemma 1 (ub interval score) above, if inverse document scores (IDFScores) of all of these search terms are 1, and the combination function ⊕ is sum, the ub interval score of the first interval [1,3) is 2+0+0 =2.

### Example Interval Generation Algorithm

In operation, the interval generator module 202 may utilize any number of suitable algorithms or other means to partition the range into intervals with ub interval scores. As but one example, consider the following algorithm GENERATEINTERVALS which may be implemented in some embodiments:

Example Algorithm 1: GENERATEINTERVALS

```
  Input: Metadata of blocks for each query term
  Output: List V of intervals
  1: V ← ø
  2: {p₁,...,pₘ} ← Sort startpoints and endpoints of all blocks of query
terms
  3: for i = 1 to n do
  4: Vₚᵣₑᵥ.blockNum[i] ← GAP
  5: for j = 1 to m do
  6: V_{curr}.span ← span (pⱼ,pⱼ₊₁)
  7: for i = 1 to n do
  8: if [symbol] i,b [symbol]  ∈ StartingBlocks (pⱼ) then
  9: V_{curr}.blockNum[i] ← b
10: else if [symbol] i,b [symbol]  ∈ EndingBlocks (pⱼ) then
11: V_{curr}.blockNum[i] ← GAP
12: else
13: V_{curr}.blockNum[i] ← Vₚᵣₑᵥ.blockNum[i]
14: if pⱼ is bothpoint then
15: V_{singleton}.span[i] ← [pⱼ,pⱼ₊₁]
16: for i = 1 to n do
17: if [symbol]   i,b [symbol]   ∈ StartingBlocks (pⱼ) ∪ EndingBlocks (pⱼ) then
18: V_{singleton}.blockNum[i] ← b
19: else
20: V_{singleton}.blockNum[i] ← Vₚᵣₑᵥ.blockNum[i]
21: if SatisfiesBooleanExpression (V_{singleton}) then
22: Compute V_{singleton}.ub interval score as per example definition
2 (ub interval score)
23: V.Append (V_{singleton})
24: if SatisfiesBooleanExpression (V_{curr}) then
25: Compute V_{curr}.ub interval score as per example definition 2
(ub interval score)
26: V.Append (V_{curr})
27: Vₚᵣₑᵥ ← V_{curr}
28: return V
```

GENERATEINTERVALS can be utilized to generate intervals using the summary data of blocks for search terms. Consider for example a simple case where all the blocks of these search terms have distinct startpoints and endpoints. Let {p₁, . . . , pₙ} denote the startpoints and endpoints of all the blocks in doc ID order. Each pair {pⱼ, pⱼ₊₁} of consecutive points in the above sequence is an interval. A certain interval corresponding to {pⱼ₋₁, pⱼ} or to {pⱼ, pⱼ₊₁} can be identified to include the boundary point pⱼ. It can be argued that pⱼ should be included in the interval that overlaps with the block of which pⱼ is the startpoint/endpoint. One of the two intervals satisfies this condition. Including pⱼ in the other interval can or will violate (example definition 1 (interval)) above and lead to incorrect ub interval scores.

For example, consider boundary point 3 in FIG. 4. Boundary point 3 is the startpoint of block q₂-b₁, ubs=2 and overlaps with [3,4] but not with [1,3), so boundary point 3 is included in [3;4]. If boundary point 3 were included in [1,3), it would end up overlapping with one gap and one block for both terms q₂ and q₃ and hence violate the above interval definition.

If a Boolean expression is specified in the expression 108 of the search query 106, output can be limited to intervals that can satisfy the Boolean expression. For example, for “AND”, only intervals that overlap with a block for each search term (q₁, q₂, and q₃) can be output. For each output interval ν, a block number ν.blockNum[i] of the blocks overlapping with ν for each query term qᵢ and ν's ub interval score (ν.ubscore) can be output. If ν overlaps with a gap for qᵢ, a special value denoted by “GAP” can be assigned to ν.blockNum[i] to indicate the overlap. Note that the intervals can be output in doc ID order.

Often, multiple blocks (corresponding to different search terms) may begin and end at the same boundary point. GENERATEINTERVALS can be correct even if multiple blocks start at the same point or end at the same point. However, if different blocks start as well as end at the same point pⱼ, that pⱼ cannot be included in either the interval corresponding to {(pⱼ−1, pⱼ}) or that corresponding to {pⱼ, pⱼ+1} without violating example definition 1 (Interval) above. In such a case, it can be excluded from both those intervals and an additional Singleton interval [pⱼ, pⱼ] can be generated. As noted above, one example of a Singleton interval is denoted in 410 as “[12, 12]”.

### Example Interval Pruning Algorithms

In operation, the interval pruning module 204 may utilize any number of suitable algorithms or other means to evaluate (and potentially process) intervals (based on their ub interval scores), prune prunable intervals, and process non-prunable intervals. As explained above, a non-prunable interval can be processed by reading and decompressing individual blocks overlapping the non-prunable interval, and then invoking a DAAT algorithm on the non-prunable interval.

With respect to evaluating intervals, generally speaking the order in which individual intervals are considered for processing can impact the number of blocks that are decompressed and the number of doc IDs processed, as well as the cost of accessing each of the blocks that have been decompressed. For example, intervals can be evaluated, or considered for processing, in doc ID order (i.e., according to their respective positions in the range) and/or in ub interval score order (i.e. according to their respective ub interval scores). Evaluating intervals in doc ID order may be associated with lower per-block access costs but may also be associated with higher decompression and merge and score computation costs. Evaluating intervals in score order, on the other hand, may be associated with higher per-block access costs (due at least in part to random input/output (I/O) disk access operations), but may also be associated with lower decompression and DAAT costs.

The above limitations are addressed in the example interval pruning algorithms below (PRUNESEQ, PRUNESCOREORDER, PRUNESCOREORDER, and PRUNELAZY). These example algorithms, which may be referred to as subrange DAAT executions, may take a list of the individual intervals of the range and their corresponding ub interval scores as input.

### Example Lemma 2

PRUNESEQ, PRUNESCOREORDER, PRUNESCOREORDER, and PRUNELAZY perform correct subrange DAAT executions.

In some embodiments, a subrange DAAT execution (e.g., PRUNESEQ, PRUNESCOREORDER, PRUNESCOREORDER, or PRUNELAZY) can be considered correct for search query sq if the subrange DAAT execution satisfies the following example correctness property:

### Example Property 1 (Correctness)

Let S(e) denote a set of subranges processed by a subrange DAAT execution e. Let docids(s) denote the set of doc IDs in the posting lists of the query terms (for search query sq) that fall within the subrange s. The execution e is correct only if ∪_{sεS(e)} docids(s) includes the top-k doc IDs for search query sq.

Note that each of the example interval pruning algorithms described below maintains the set CURRTOPK of k highest scoring doc IDs (per interval as the top doc ID score) seen so far and tracks the minimum doc ID score of a current set of top-k doc IDs, which may be referred to as a threshold score. In this regard, the threshold score may be thought of as the highest doc ID score seen so far during interval evaluation that any doc ID (and thus corresponding document) in an evaluated interval can have according to the constraints of the query.

Consider the following example interval pruning algorithm PRUNESEQ which evaluates intervals in ascending doc ID order, in accordance with some embodiments:

Example Algorithm 2: PRUNESEQ

```
      Input: List V of intervals in docid order, k, cursor
      Output: Top k docids and their scores
      Let CURRTOPK denote the set of k highest docids seen so far
      (initialized to Ø)
      Let CURRBLKS denote the decompressed blocks overlapping with
interval being processed
  1: for j = 1 to |V| do
  2:  if V[j].ubscore > thresholdScore then
  3:  for i = 1 to n do
  4:  if V[j].blockNum[i] ≠ GAP then
  5:  if currblks[i].blockNum≠ V[j].blockNum[i] then
  6:  currblks[i].Postings ← Decompress
            (cursor[i].ReadBlockSeq(V[j].blockNum[i]))
  7:  else
  8:  Clear block in CURRBLKS[i]
  9:  EXECUTEDAATONINTERVAL(currblks, V[j],CURRTOPK, k)
10: return CURRTOPK
```

In operation, PRUNESEQ can perform sequential I/O disk access operations as blocks of a range are read in doc ID order (e.g., the order in which they are stored on disk). Given that PRUNESEQ can evaluate intervals and prune prunable intervals, the number of blocks (and thus doc IDs) that are decompressed and processed can be significantly reduced.

More particularly, individual intervals can be checked to determine whether they can contribute at least one doc ID to top-k results to be returned in the search results 112. If an individual interval can contribute at least one doc ID, then it can be considered a non-prunable interval. However, if the individual cannot contribute to the at least one doc ID, then it can be considered a prunable interval, and can thus be pruned.

Each determined non-prunable interval can be read (e.g., from disk), decompressed, and processed using a DAAT algorithm. In some embodiments, the non-prunable interval may be read using a particular block reading API of the inverted index 116. For example, PRUNESEQ utilizes/calls READBLOCKSEQ to accomplish this.

With respect to checking individual intervals to determine whether they can contribute at least one doc ID, at line 2 PRUNESEQ determines if an interval being evaluated can contribute a doc ID if the interval's ub interval score is greater than the threshold score.

With respect to reading blocks, note that an individual block can overlap with multiple intervals. Accordingly, to avoid reading the individual block from disk and decompressing it multiple times, at lines 3-8 PRUNESEQ can read and decompress the individual block once and then retain the decompressed block in CURRBLKS until the block is no longer needed (i.e., no subsequent interval to be evaluated overlaps with it).

With respect to processing non-prunable intervals, at line 9 PRUNESEQ can call EXECUTEDAATONINTERVAL to execute the DAAT algorithm over the span of each non-prunable interval (i.e., from the non-prunable interval's startpoint to its endpoint). To locate a starting point in the blocks overlapping a non-prunable interval, a binary search can be used. The DAAT algorithm can update the CURRENTTOPK highest scoring doc IDs.

As a practical example, consider the execution of PRUNESEQ on the intervals of the range 400. Referring to FIG. 4, assume for the sake of discussion that the expression 108 includes the top-k constraint of k=1, doc ID scores are calculated as ⊕_{tεq∩d} term score (e.g., TFScore)×IDFScore, and IDFScore=1. The top single-most relevant document in the document collection 102, and/or the doc ID for that document, can be returned in the search results 112. Also assume that the expression 108 includes the Boolean expression “AND” separating search terms q₁, q₂, and q₃. (i.e., “q₁ AND q₂ AND q₃”). In operation, PRUNESEQ may process the intervals in doc ID order from left to right along the doc ID range span 402 before reaching interval [8,10]. At this stage, note that the threshold score will be “4” because the highest doc ID score that any doc ID (and thus corresponding document) evaluated up to that point can have is 4:“1” for “{3,1}” of q₁-b₁, ubs=2, “1” for “{3,1}” of q₂-b₁, ubs=2, and “2” for “{3,2}”of q₃-b₁, ubs=8 (i.e., “1+1+2=4”).

Once PRUNESEQ reaches interval [8,10], PRUNESEQ will determine that interval [8,10] is non-prunable since interval [8,10]'s ub interval score of “13” is greater than the threshold score “4”. PRUNESEQ will also change the threshold score to “12” since the highest doc ID score seen so far is now “12”: (“2” for “{9,2}” of q₁-b₃, ubs=3, “2” “{9,2}” q₂-b₁, ubs=2 , and “8” for “{9,8}” of q₃-b₁, ubs=8 (i.e., “2+2+8=12”). PRUNESEQ will then evaluate intervals (10,13), [12,12], and (12,14] and determine that these intervals are prunable since their ub interval scores are not greater than the new threshold score “12”. As a result, since block q₂-b₂, ubs=1 does not overlap a non-prunable interval, it will not be read or decompressed by PRUNESEQ.

Consider another interval pruning algorithm PRUNESCOREORDER which evaluates intervals in order of their ub interval scores (i.e., in interval score order), in accordance with some embodiments:

Example Algorithm 3: PRUNESCOREORDER

```
  Input: List V of intervals in docid order, k
  Output: Top k docids and their scores
  1: V_{scoreordered}<- List V of intervals sorted by ubscore
  2: for j=1 to |V_{scoreordered} | do
  3:  if V_{scoreordered}[j].ubscore≦thresholdScore then
  4:  return CURRTOPK
  5:  Clear blocks in currblks
  6:  for i = 1 to n do
  7:  if V_{scoreordered}[j] blockNum[i] ≠ GAP then
  8:  currblocks[i] ← BlockCache.Lookup(V_{scoreordered} [j].
          blockNum[i])
  9:  if currblocks[i] = NULL then
10:  currblocks[i] ← Decompress (READBLOCKRAND(V[j].
            blockNum[i]))
11:  BLOCKCACHE.ADD(currblocks[i])
12:  EXECUTEDAATONINTERVAL(currblocks,V[j],CURRTOPK, k)
```

In operation, PRUNESCOREORDER can evaluate intervals in a decreasing order of the intervals' corresponding ub interval scores. In this regard, PRUNESCOREORDER can evaluate the intervals to determine the highest doc ID score. The highest doc ID score can be used as the threshold score. The intervals can then be processed in decreasing order of their corresponding ub interval scores until an interval with a ub interval score less than or equal to the threshold score is encountered. Since the remaining intervals cannot contribute a doc ID to the top-k results, the evaluation can then be terminated. To accomplish this however, PRUNESCOREORDER performs random I/O disk access operations which may be more computationally expensive than sequential I/O disk access operations, such as performed by PRUNESEQ for instance. However, the costs associated with performing these random I/O disk access operations may, in some circumstances, be offset by the avoidance of block decompression costs and DAAT costs that might otherwise be incurred.

As a practical example, consider the execution of PRUNESCOREORDER on the intervals of the range 400. Referring to FIG. 4, assume again for the sake of discussion that the expression 108 includes the top-k constraint of k=1 and t the Boolean expression “AND” separating search terms q₁, q₂, and q₃. In operation, PRUNESCOREORDER may evaluate the intervals of the range 400 to identify interval [8,10], which has the highest doc ID score of “12”. The evaluation may then be terminated since, based on the expression 108, blocks not spanning interval [8,10] cannot contribute at least one doc ID to the top-k results to be returned.

PRUNESEQ and PRUNESCOREORDER can be considered as being representative of two relatively extreme points of the tradeoff between the costs of random I/O disk access operations and benefits of evaluating intervals in ub interval score order. Consider another interval pruning algorithm, PRUNEHYBRID, which seeks to achieve a compromise (an intermediate point) between the two relatively extreme points in accordance with some embodiments:

Example Algorithm 4: PRUNEHYBRID

```
  Input: List V of intervals in docid order, |rho, k
  Output: Top k docids and their scores
  1: Vₜₒₚ ←TOPρ×|V | intervals ordered by ubscore
  2: for j=1 to |Vₜₒₚ | do
  3:  if Vₜₒₚ[j].ubscore ≦ thresholdScore then
  4:  return CURRTOPK
  5:  Clear blocks in currblks
  6:  for i = 1 to n do
  7:  if Vₜₒₚ[j]blockNum[i] ≠ GAP then
  8:  currblocks[i] ← BlockCache.Lookup (Vₜₒₚ [j].blockNum[i])
  9:  if currblocks[i] = NULL then
10:  currblocks[i] ← Decompress (READBLOCKRAND(V [j].
            blockNum[i]))
11:  BLOCKCACHE.ADD(currblocks[i])
12:  EXECUTEDAATONINTERVAL(currblocks,V[j],CURRTOPK, k)
13: Process unprocessed intervals in docid order as in PRUNESEQ
14: return CURRTOPK
```

In operation, in a first phase PRUNEHYBRID can evaluate a first number (e.g., a relatively small number) of intervals of the range in ub interval score order. If an interval of the first number of intervals with a ub interval score less than or equal to the threshold score is encountered, the evaluation can be terminated. However, if such an interval is not encountered, in a second phase PRUNEHYBRID can evaluate the remaining intervals of the range (possibly a relatively large number) in doc ID order. This can result in the avoidance of significant decompression and DAAT costs in many situations.

For example, often doc IDs from intervals evaluated during the first phase may result in a set of current top-k documents that are strong candidates for satisfying top-k results to be returned. The threshold score can be considered a “tight” lower bound of the final top-k documents results that will be returned. As such, a relatively large number of intervals can be pruned (e.g., as compared to PRUNESEQ), thus avoiding decompression costs and merge and computation costs that might otherwise be incurred.

Referring to the PRUNEHYBRID algorithm, note that the fraction of intervals processed in score order (specified by input parameter p) determines the intermediate point(s) of the above-mentioned tradeoff. With at least some of these intermediate points, the costs associated with random I/O disk access operations may be lower than the savings in decompression and DAAT costs, thus resulting in an overall IR cost reduction.

With respect to block caching, note that in PRUNEHYBRID, during the first phase a block can overlap with multiple intervals in vₜₒₚ. To avoid accessing the block randomly from disk and decompressing the block multiple times, decompressed blocks of a processed interval can be cached in BLOCKCACHE. When processing an interval, it can first be determined whether or not a corresponding block of the interval has already been read, decompressed, and cached in BLOCKCACHE.

If the corresponding block has already been read, decompressed, and cached in BLOCKCACHE, then the cached block can be used. However, if the corresponding block has not already been read, decompressed, and cached, it can be read (e.g., from disk), decompressed, processed, and inserted in BLOCKCACHE (see lines 10-11 of PRUNEHYBRID). In some embodiments, a standard least recently used (LRU) cache replacement policy and a fixed size cache (e.g., 1000 blocks sharable over multiple queries) can be utilized.

As a practical example, consider the execution of PRUNEHYBRID on the intervals of the range 400. Referring to FIG. 4, assume again for the sake of discussion that expression 108 includes the top-k constraint of k=1 and the expression 108 includes the Boolean expression “AND” separating each of the search terms. Also assume that |rho=1. In operation, PRUNEHYBRID can evaluate the top 0.1×9≈1 interval(s) (i.e., interval [8,10]) in ub interval score order. At this stage, the threshold score will be 12. PRUNEHYBRID can then evaluate the remaining intervals sequentially and prune them. Thus, PRUNEHYBRID can avoid the reading and decompression of blocks q₁-b₁, ubs=2, q₁-b₂, ubs=2, and q₂-b₂, ubs=1 since these blocks do not overlap the span of interval [8,10].

Consider another interval pruning algorithm PRUNELAZY which seeks to decouple the notions of block reading from other interval processing operations by utilizing an allocated memory buffer.

Example Algorithm 5: PRUNELAZY

```
  Input: List V of intervals in docid order, M, k, cursor
  Output: Top k docids and their scores
  Let buffer denote the compressed blocks gathered during the gather
phase (initialized to Ø)
  Let processedTill denote the last interval till which all intervals have been
either processed or pruned (initialized to 0)
  Let gatheredTill denote the last interval till which all intervals have been
gathered initialized to Ø
  1: GATHERPHASE:
  2: for j = j=(processedTill+1) to |V | do
  3:  if V[j].ubscore >thresholdScore then
  4:  for i = 1 to n do
  5:  if V [j].blockNum[i] ≠ GAP and
            buffer[i, V[j].blockNum[i]] ≠ Ø then
  6:  if size(buffer) ≦ M then
  7:  buffer[i, V[j].blockNum[i]] ←
              (cursor[i].ReadBlockSeq(V[j].blockNum[i]))
  8:  else
  9:  gathered Till ← j − 1
10:  goto PROCESSPHASE
11: gatheredTill ←|V |
12: PROCESSPHASE:
13: V_{ordered} ← {V[j],j = processedTill + 1, ..., gatheredTill} ordered by
ubscore
14: for j = 1 to |V_{ordered}| do
15:  if V_{ordered} [j].ubscore < thresholdScore then
16:  processedTill ← gatheredTill
17:  ... buffer← Ø
18:  goto GATHERPHASE
19:  Clear blocks in currblks
20:  for i = 1 to n do
21:  if Vₜₒₚ[j].blockNUM[i] is not a GAP then
22:  currblocks[i] ← BlockCache.Lookup(Vₜₒₚ[[j].blockNum[i])
23:  currblocks[i] = NULL then
24:  currblocks[i] ← Decompress(buffer[j,V[j].block[i]])
25:  BlcokCache.Add(currblocks[i])
26: ExecuteDAATOnInterval(currblocks,V[j],currTopK,k
27: return currTopK
```

Generally speaking, PRUNELAZY can leverage a given amount of memory by toggling between two phases. More particularly, PRUNELAZY can toggle between two phases, a gather phase and a process phase, to evaluate and process intervals in the range. Each of these phases is described below.

Gather phase: During this phase, intervals of the range can be evaluated in doc ID order in a manner similar to PRUNESEQ described above. During this phase, if an individual interval being evaluated cannot contribute at least one doc ID to the top-k results, it is determined to be prunable and is thus pruned. If, on the other hand, the individual interval can contribute at least one doc ID, a block(s) overlapping the individual interval can be read from disk. However, unlike PRUNESEQ, the block(s) may not be decompressed immediately or soon thereafter. Instead, the block(s) can be stored in an allocated memory buffer. When the allocated memory buffer is full, PRUNELAZY can toggle to the process phase.

Process phase: during this phase, intervals with blocks stored in the memory buffer can be processed in ub interval score order in a manner similar to PRUNESCOREORDER and PRUNEHYBRID described above. However, unlike these algorithms, when a block to be processed (i.e., a block overlapping a non-prunable interval) cannot be found in a cache (e.g., such as in BLOCKCACHE described above), the block can be read from the memory buffer rather than, for example, from disk. The block can then be decompressed and processed using a DAAT algorithm. When a termination condition with respect to the intervals with blocks stored in the memory buffer is satisfied, the memory buffer can be cleared. PRUNELAZY can then toggle to the gather phase. PRUNELAZY can continue to toggle between the gather phase and the process phase until all the intervals have been pruned or processed.

Note that in the PRUNELAZY algorithm, the variables PROCESSEDTILL and GATHEREDTILL are used to track the current set of intervals being gathered/processed. In an iteration, the gather phase starts gathering from PROCESSEDTILL+1 and sets GATHEREDTILL when the memory is full. The process phase processes the intervals from PROCESSEDTILL+1 to GATHEREDTILL (in ub interval score order) and sets PROCESSEDTILL to GATHEREDTILL when the phase terminates.

### Example Lemma 3: (PRUNELAZY)

given keyword query q and the summary information for each term, PRUNELAZY can be optimal when M≧Σᵢbᵢ, where M is the allocated memory (in number of blocks) and bᵢ is the number of blocks of the ith query term.

As a practical example, consider the execution of PRUNELAZY on the intervals of the range 400. Referring to FIG. 4, assume for the sake of discussion that the expression 108 includes the top-k constraint of k=1, the expression 108 includes the Boolean expression “AND” separating each of the search terms, and M=5. In operation, during a gather phase PRUNELAZY may evaluate the intervals of the range 400 in doc ID order and gather blocks (q₁-b₁, ubs=2, q₁-b₂, ubs=2, q₂-b₁, ubs=2, q₃-b₁, ubs=8, and q₁-b₃, ubs=3) into an allocated memory buffer until reaching interval (10,13). At this point, PRUNELAZY may then toggle to a process phase.

During the process phase, PRUNELAZY may read the blocks overlapping interval [8,10] from the allocated memory buffer (if not cached), decompress them, and process the decompressed blocks using a DAAT algorithm. Since the threshold is set to “12”, PRUNELAZY may prune the other intervals associated with the blocks in the allocated memory buffer (i.e., intervals [1,3), [3,4], [5,7), and (7,8)). After clearing the allocated memory buffer, PRUNELAZY may then toggle back to the gather phase to gather the remaining block (q₂-b₂, ubs=1). PRUNELAZY may then toggle back to the process phase and prune intervals (10,13) [12,12], and (12,14] since the threshold score remains “12”. PRUNELAZY can avoid decompressing blocks q₁-b₁, ubs=2, q₁-b₂, ubs=2, and q₂-b₂, ubs=1.

### Fancy Lists

When a block contains a doc ID with a very high term score, that block may have a very high ub block score and intervals the block overlaps with may also tend to have high ub interval scores. However, many of these overlapping intervals may either have zero results or contain doc IDs with term scores much lower than each of these interval's corresponding ub interval score. For example, in the context of the range 400, block q₃-b₁, ubs=8 has a relatively high ub block score of “8” since it includes doc ID posting {9,8} (doc ID “9” with term score “8”). All of the overlapping intervals (starting from [3,4] to [12,12]) have high ub interval scores. Among these overlapping intervals however, only interval [8,10] has posting {9,8}.

In many scenarios, only a small fraction of doc IDs in a posting list may have such high term scores. In some embodiments, ub interval scores can be “tightened” by excluding doc IDs with high term scores, such as doc ID posting {9,8}. In some embodiments, a module such as interval generation module 202 can be configured to isolate doc IDs with a designated top percentage (e.g., the top 1%) of term scores. For example, excluding doc ID 9 from block q₃-b₁, ubs=8 may significantly decrease the ub interval scores of intervals [3,4] to [12,12] from “12, 10, 12, 10, 13, 11, and 12” to tighter ub interval scores “5, 3, 5, 3, 6, 4, and 5” respectively. These tighter ub interval scores may imply that the intervals [3,4] to [12,12] can be pruned out by an interval pruning algorithm, such as the example pruning algorithms described above.

For individual terms of a document collection, doc IDs with the highest term scores, such as doc ID discussed above for instance, can be listed in so called “fancy lists” and used to approximate top-k results. By way of example and not limitation, in some embodiments, doc IDs with approximately the top 1 percent (top 1%) highest term scores for a particular term may be included in a corresponding fancy list. As noted above, a metadata section of an individual posting list, such as the metadata section 302 of posting list tᵢ described above for instance, may include a fancy list(s) of such doc IDs associated with that individual posting list.

In some embodiments, fancy lists and posting lists that include fancy lists may be leveraged in accordance with the described interval-based IR search techniques. For example, in the context of example interval generation algorithm GENERATEINTERVALS described above, this algorithm can be configured to utilize fancy lists for search terms in an inputted search query. [000103] In some embodiments, a fancy interval f_{d} for each doc ID d in a fancy list for each search query term can be generated. In addition to a first set of intervals that are not fancy (i.e., non-fancy intervals), a second set of fancy intervals may also be generated. As with non-fancy intervals, fancy intervals satisfying a Boolean expression of the search query can be evaluated and/or processed. [000104] Note that d need not be included in the fancy list of all the search terms of a query search (this in fact may be uncommon). For each f_{d}, an f_{d} ub interval score for f_{d} can be obtained as follows. When d is in a fancy list of qᵢ, the f_{d} ub interval score f_{d}.ubscore[i] of f_{d} for qᵢ can be obtained from the fancy list of qᵢ. Otherwise, f_{d}.ubscore[i] can be obtained from a block or gap that d overlaps with for qᵢ, as described above in example definition 2 (ub interval score). The overall f_{d}.ubscore is ⊕ᵢf_{d}.ubscore[i]×IDFScore (qᵢ, D) as described in example definition 2 (ub interval score). [000105] In some embodiments, the following lemma with respect to fancy intervals can be applied.

### Example Lemma 4: (Fancy Interval ub Interval Scores)

the ub interval score of a fancy interval upper bounds the score of the doc ID contained in the interval.

Interval pruning algorithms, such as the example algorithms described above, can also be configured to utilize fancy lists for search terms in an inputted search query. For example, the above interval pruning algorithms can evaluate fancy intervals of (based on their ub interval scores) and prune prunable fancy intervals in a manner similar to non-fancy intervals. However, processing fancy intervals with a DAAT algorithm can be performed in a slightly different fashion. More particularly, in some embodiments for a doc ID in a fancy list, the doc ID's term score can be obtained from the fancy list itself.

### Block Signatures

In addition to compressed postings, in some embodiments individual blocks may also have corresponding signatures, such as signatures s₁-s_{N} in the block section 208 for instance. Signatures may be used to further avoid unnecessary interval processing. More particularly, consider a scenario where a search query expression includes query search terms and one or more Boolean expressions (e.g., “AND”) describing the search terms and thus influencing how the search query is to be answered. An interval of a range for the search query may have a high ub interval score but may not contain any doc IDs that satisfy the Boolean expression. Such an interval can be referred to as having zero results since it has zero doc IDs that that can satisfy the Boolean expression. As but one example of such an interval, consider interval [5,7) in the range 400 described above.

To avoid processing such an interval, a signature can be computed and stored for each block in the range. Each signature can include information about its corresponding block at a fine granularity. Before processing (i.e., decompressing blocks and invoking a DAAT algorithm) an interval that has not been pruned, signatures of an individual block overlapping the interval can be assessed to determine whether the interval has any doc IDs that may be included in the search results. In this way, the interval can effectively be checked to determine whether it has zero results or whether it has a non-zero result (i.e. has at least one doc ID that satisfies the Boolean expression). If the interval passes the check and has a non-zero result, it may be processed. However, if the interval does not pass the check (i.e. has zero results), it may not be processed. In this way, costs that might otherwise be incurred by processing intervals with zero results can be avoided.

In some situations, it is possible that the costs associated with checking signatures of intervals of the range not pruned may outweigh the benefits associated with avoiding processing intervals with zero results. For example, consider a scenario where most or all of the intervals of the range not pruned pass the check as having a non-zero result. In such a scenario, checking the signatures of all the blocks overlapping these intervals may result in an overall increase in costs. To avoid such a result, in some embodiments, the blocks of only a portion of the intervals not pruned may be checked.

In some embodiments, an example signature scheme is described below for determining which intervals (that have not been pruned) in the range to check. The example signature scheme can produce no false positives. For purposes of discussion, the example scheme can be described in the context of a scenario where a search query expression includes query search terms and one or more “AND” Boolean expressions.

In the example signature scheme, a global doc ID range can be partitioned into consecutive intervals having a fixed-width range (i.e., each interval spanning the same width r of the global doc ID range). Individual blocks can overlap with a set of the fixed-width ranges. For each block, a bitvector can be computed with one bit corresponding to each fixed-width range the block overlaps with. In this regard, an individual bit can be set to true when the block contains a doc ID in that fixed-width range and false otherwise. The bitvector can be used as the signature of the block and stored in each block, such as with signatures s₁-s_{N} stored in the block section 208 above for instance.

To perform a check on interval v, for each block overlapping with ν, a bitwise-AND bitwise operation can be performed on the “portion” of the block's bitvector overlapping with v. If at least one bit in the result is set, the check is satisfied.

Note that the width r of the ranges may present a tradeoff between the pruning power checking intervals and the cost of performing the checking. A width r can be selected such that the cost of performing checking is a fraction (e.g., 25-50%) of processing the block. Note that the width r can also affect the size of signatures. This, however, can be mitigated by compressing the signatures using a scheme such as run length encoding for example.

In operation, the probability of the check being satisfied for a particular interval can be estimated. If the estimated probability is below a threshold value, the particular interval can be determined to be checkable. Otherwise, the particular interval can be determined to be non-checkable. More particularly, the particular interval can then be checked if the estimated probability is below a threshold value θ. If the estimated probability is below the threshold value, the particular interval can be determined to be checkable. Otherwise, the particular interval can be determined to be non-checkable. Example techniques for estimating this probability and determining the threshold value θ, in accordance with some embodiments, are described in detail below.

Example technique for estimating whether a probability check is satisfied: for an interval ν, let d(b) denote the fraction of bits in the signature of block b that are set to 1. The probability of a bit in the result of bitwise-AND being set can be πᵢd (ν.blockNurn[i]). The number of bits for the interval can be

$$\frac{w ( v )}{r}$$

where w(ν) is the width of the interval. The probability that at least one of the bits is set (the probability of the check being satisfied) can be

$$1 - ( 1 - {Π}_{i} d {( v . blockNum [ i ] )}^{\frac{w ( v )}{r}} .$$

Example technique for determining threshold value ⊕: let e(ν) denote the estimated probability that interval ν satisfies the check. Let c_{ch} (V) denote the cost of the check and cₚᵣ(ν) denote the computing cost of decompressing blocks and DAAT processing for interval ν. Note that cₚ(ν)=c_{dc}N_{b}(ν)+c_{daat}N_{d}(ν), where c_{dc} is the average cost of decompressing a block, N_{b}(ν) is the number of blocks overlapping with interval ν, c_{daat} is the average cost of DAAT processing per doc ID (e.g., doc ID comparison costs, final score computing costs, etc.), and N_{d}(ν) is the number of doc IDs contained in ν. Assuming c_{ch}(ν)=λ×cₚᵣ(ν) for some constant λ≦1, the cost can be:

P(e(ν)≦θ×(C_{ch}(ν)+e(ν)×Cₚᵣ(ν))+P(e(ν)>θ)×Cₚᵣ(ν)=(λ×P(e(ν)≦θ)+e(ν)×P(e(ν)≦θ)+P(e(ν)>θ))×Cₚᵣ(ν)

Let f(x) be the probability distribution of e(ν). The expected cost E(θ) can be:

(λ×∫₀^{θ}f(x)+∫₀^{θ}xf(x)+1−∫₀^{θ}f(x))×E(Cₚᵣ(ν)).

The expected cost can be minimized when

$$\frac{d E ( θ )}{d θ} = 0 ,$$

i.e.,

λ×f(θₒₚₜ)+θₒₚₜf(θₒₚₜ)−f(θₒₚₜ)=0

Hence, the optimal threshold value θₒₚₜ can be (1−λ).

### Example Operating Environment

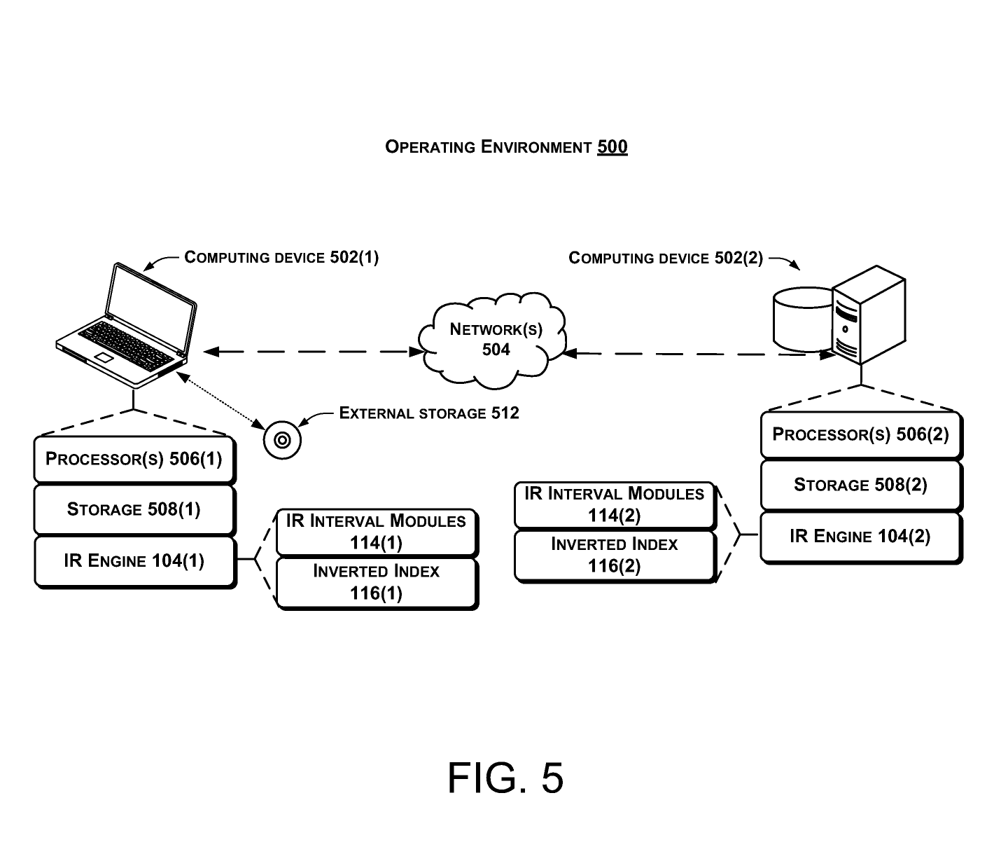

FIG. 5 illustrates an example operating environment 500 in which the described interval-based IR search techniques may be implemented, in accordance with some embodiments. For purposes of discussion, the operating environment 500 is described in the context of the system 100. Like numerals from FIG. 1 have thus been utilized to depict like components. However, it is to be appreciated and understood that this is but one example and is not to be interpreted as limiting the system 100 to only being implemented in the operating environment 500.

In this example, the operating environment 500 includes first and second computing devices 502(1) and 502(2). These computing devices can function in a stand-alone or cooperative manner to interval-based IR searching. Furthermore, in this example, the computing devices 502(1) and 502(2) can exchange data over one or more networks 504. Without limitation, network(s) 504 can include one or more local area networks (LANs), wide area networks (WANs), the Internet, and the like.

Here, each of the computing devices 502(1) and 502(2) can include a processor(s) 506 and storage 508. In addition, either or both of these computing devices can implement all or part of the IR engine 104, including the IR interval modules 114 and/or the inverted index 116. As noted above, the IR engine 104 can be configured to support keyword searching over the document collection 102 utilizing the described interval-based IR search techniques. Either or both of the computing devices 502(1) and 502(2) may receive search queries (e.g., the search query 106) and provide search results (e.g., the search results 112).

The processor(s) 506 can execute data in the form of computer-readable instructions to provide a functionality. Data, such as computer-readable instructions can be stored on the storage 508. The storage can include any one or more of volatile or non-volatile memory, hard drives, optical storage devices (e.g., CDs, DVDs etc.), among others.

The devices 502(1) and 502(2) can also be configured to receive and/or generate data in the form of computer-readable instructions from an external storage 512. Examples of external storage can include optical storage devices (e.g., CDs, DVDs etc.) and flash storage devices (e.g., memory sticks or memory cards), among others. The computing devices may also receive data in the form of computer-readable instructions over the network(s) 504 that is then stored on the computing device for execution by its processor(s).

As mentioned above, either of the computing devices 502(1) and 502(2) may function in a stand-alone configuration. For example, the IR interval modules and the inverted index may be implemented on the computing device 502(1) (and/or external storage 512). In such a case, the IR engine might provide the described interval-based IR searching without communicating with the network 504 and/or the computing device 502(2).

In another scenario, one or both of the IR interval modules could be implemented on the computing device 502(1) while the inverted index, and possibly one of the IR interval modules, could be implemented on the computing device 502(2). In such a case, communication between the computing devices might allow a user of the computing device 502(1) to achieve the described interval-based IR searching.

In still another scenario the computing device 502(1) might be a thin computing device with limited storage and/or processing resources. In such a case, processing and/or data storage could occur on the computing device 502(2) (and/or upon a cloud of unknown computers connected to the network(s) 504). Results of the processing can then be sent to and displayed upon the computing device 502(1) for the user.

The term “computing device” as used herein can mean any type of device that has some amount of processing capability. Examples of computing devices can include traditional computing devices, such as personal computers, cell phones, smart phones, personal digital assistants, or any of a myriad of ever-evolving or yet to be developed types of computing devices.

### Exemplary Methods

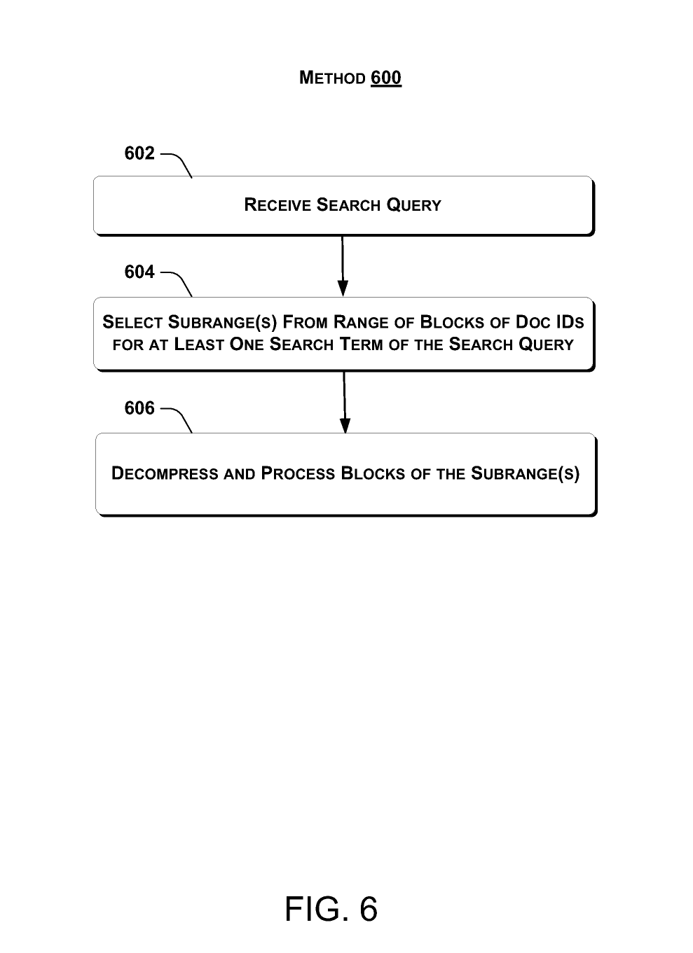

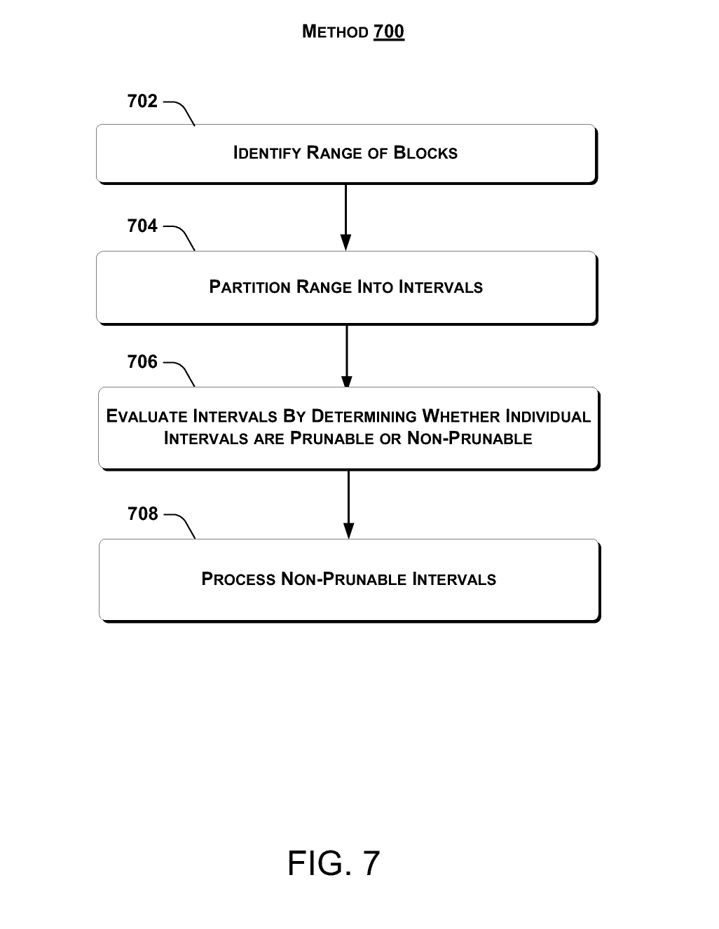

FIGS. 6 and 7 illustrate flowcharts of processes, techniques, or methods, generally denoted as method 600 and method 700 respectively, that are consistent with some implementations of the described interval-based IR search techniques. The orders in which the methods 600 and 700 are described are not intended to be construed as a limitation, and any number of the described blocks can be combined in any order to implement the method, or an alternate method. Furthermore, each of these methods can be implemented in any suitable hardware, software, firmware, or combination thereof such that a computing device can implement the method. In some embodiments, one or both of these methods are stored on a computer-readable storage media as a set of instructions such that, when executed by a computing device(s), cause the computing device(s) to perform the method(s).

Regarding the method 600 illustrated in FIG. 6, block 602 receives a search query, such as a top-k query for example. As described above, the search query can have an expression with a one or more search terms and, in some cases, one or more Boolean expressions describing the term(s).

Block 604 selects one or more subranges from a range of blocks having doc IDs for at least one of the search terms. As explained above, the subrange(s) can be selected by partitioning blocks in the range into intervals and evaluating the intervals to determine whether individual intervals are prunable or non-prunable. This can also be accomplished without decompressing the blocks by utilizing the interval's interval scores. In some embodiments, an interval generating algorithm such as GENERATE INTERVALS described above can be utilized to partition the blocks in the range into the intervals. Furthermore, in some embodiments, an interval pruning algorithm(s) such as PRUNESEQ, PRUNESCOREORDER, PRUNESCOREORDER, and/or PRUNELAZY described above can be utilized to evaluate the intervals.

Individual blocks overlapping a non-prunable interval(s) can then be selected as the subrange of blocks. Blocks overlapping a prunable interval and not overlapping a non-prunable interval can be pruned. The selected subrange(s) can have fewer blocks than the entire range. In other words, a second number of blocks of the subrange(s) can be less than a first number of blocks of the range.

Block 606 decompresses and processes the blocks of the subranges(s) (i.e., the second number of blocks). Since the subrange(s) have fewer blocks than the entire range, decompression and processing costs that might otherwise be incurred by processing all the blocks of the range can be avoided.

Regarding method 700 illustrated in FIG. 7, block 702 identifies a range of blocks for a search query. Individual blocks can comprise consecutive postings of doc IDs for documents containing at least one search term of the query. For example, in some embodiments an IR engine, such as the IR engine 104 described above, can identify the range of blocks as including individual doc IDs for documents containing at least one of the search query's terms.

Block 704 partitions the range into intervals. Recall that individual intervals can span at least one block and/or at least one gap between two blocks. As described above, this can be accomplished without decompressing the blocks by utilizing block summary data corresponding to each block and included in metadata sections of posting lists corresponding to the search term(s). Furthermore, each interval can also be assigned an interval score based on the block summary data. In some embodiments, an interval generating algorithm such as GENERATEINTERVALS described above can be utilized to partition the range.

Block 706 evaluates the intervals by determining whether individual intervals are prunable or non-prunable. This can also be accomplished without decompressing the blocks by utilizing the interval's interval scores. In some embodiments, an interval pruning algorithm(s) such as PRUNESEQ, PRUNESCOREORDER, PRUNESCOREORDER, and/or PRUNELAZY described above can be utilized to evaluate the intervals.

Block 708 processes intervals determined to be non-prunable (i.e., non-prunable intervals) based on the evaluating. As explained above, this can include reading and decompressing blocks overlapping each non-prunable interval. Then, the decompressed blocks can be processed to identify the one or more doc IDs, and thus one or more corresponding documents, that satisfy the search query. A DAAT algorithm can then be called/utilized to process the non-prunable intervals.

### Example Scoring Function

To assist the reader in understanding the interval-based techniques described herein, an example scoring function and example scoring considerations are provided below. This function and these considerations are merely provided to facilitate the reader's understanding, and are not intended to be limiting.

The score of a document (i.e., the document's doc ID score) can involve a search query-dependent textual component which is based on the document textual similarity to the search query, and a search query-independent static component.

First, consider the search query-dependent textual component. Assume for discussion purposes that the textual score of a document is a monotonic combination of the contributions of all the query terms occurring in the document. Formally, let ⊕ be a monotone function which takes a vector of non-negative real numbers and returns a non-negative real number. A function ƒ can be said to be monotone if ƒ(u₁, . . . , uₘ)≧ƒ(ν₁, . . . , νₘ) whenever uᵢ≧νᵢ. Then, the doc ID score, or textual score, Score(d, q, D) of a document d in a document collection D for a query q is

Score(d,q,D)=⊕_{tεq∩d} Term Score (e.g., TFScore)(d, t, D)×IDFScore(t, D)

where TFScore(d,t,D) denotes the term frequency score (one example of a term score) of document d for term t and IDFScore(t,D) denotes the inverse document frequency score of term t for document collection D. This formula, which was also described above, can cover popular IR scoring functions, such as for example, term frequency-inverse document frequency (tf-idf) or BM25. Note that it can be assumed that the term frequency scores TFScore(d,t,D) are stored as payload in individual postings. The context in which t occurs in d may impact t′s contribution to the score of d. For example, t appearing in the title or in bold face may contribute more to d's score than t appearing in the plain text of d. [000140] Now consider the search query-independent static component. These scores can be computed based on connectivity as in PageRank or on other factors such as recency or the document's source. In some embodiments, such static scores can also be incorporated into TFScore(d, t, D).

### CONCLUSION

Although techniques, methods, devices, systems, etc., pertaining to interval-based IR search techniques for efficiently and correctly answering keyword search queries are described in language specific to structural features and/or methodological acts, it is to be understood that the subject matter defined in the appended claims is not necessarily limited to the specific features or acts described. Rather, the specific features and acts are disclosed as exemplary forms for implementing the claimed methods, devices, systems, etc.

1. One or more computer-readable storage media having instructions stored thereon that, when executed by a computing device, cause the computing device to perform acts comprising:
receiving a query comprising an expression with at least one term;
selecting, from a range having a first number of blocks comprising document identifiers (doc IDs) for documents containing the at least one term, one or more subranges having a second number of blocks less than the first number of blocks; and
decompressing and processing the second number of blocks to identify at least one doc ID for at least one of the documents that satisfies the expression.

2. The one or more computer-readable storage media of claim 1, wherein the selecting is performed without decompressing the individual blocks.

3. The one or more computer-readable storage media of claim 1, wherein the selecting comprises partitioning the range into intervals and computing upper bound scores for the intervals without decompressing any of the individual blocks.

4. The one or more computer-readable storage media of claim 3, wherein the partitioning and computing is based on summary data corresponding to each of the individual blocks and stored separately from the individual blocks.

5. The one or more computer-readable storage media of claim 3, wherein the selecting further comprises:
determining whether individual intervals are prunable or non-prunable; and
selecting one or more blocks of the range that overlap at least one non-prunable interval, wherein the one or more blocks comprise the second number of blocks.

6. The one or more computer-readable storage media of claim 3, wherein the selecting further comprises:
determining whether individual intervals are prunable or non-prunable; and
determining whether individual non-prunable intervals are checkable or non-checkable based on an estimated likelihood of satisfying an interval check; and
for individual checkable non-prunable intervals, performing the interval check utilizing signatures of corresponding blocks that overlap the individual checkable non-prunable intervals.

7. The one or more computer-readable storage media of claim 6, wherein the selecting further comprises:
selecting one or more blocks of the range that overlap at least one non-checkable non-prunable interval or at least one checkable non-prunable interval satisfying the interval check, wherein the one or more blocks comprise the second number of blocks.

8. The one or more computer-readable storage media of claim 1, wherein the processing is performed utilizing a document-at-a-time (DAAT) algorithm.

9. A method comprising:
identifying a range of compressed blocks for a query, individual compressed blocks comprising consecutive postings of document identifiers (doc IDs) for documents containing at least one search term of the query;
partitioning the range into intervals, individual intervals spanning at least one compressed block or gap between two compressed blocks;
evaluating the intervals by determining whether individual intervals are prunable or non-prunable; and
based on the evaluating, processing non-prunable intervals to identify one or more individual doc IDs satisfying the query.

10. The method of claim 9, wherein the determining is performed without decompressing any of the compressed blocks and comprises:
for an individual interval, comparing an interval score of the individual interval to a threshold score;
determining that the individual interval is prunable when the interval score is not greater than the threshold score; and
determining that the individual interval is non-prunable when the interval score is greater than the threshold score.

11. The method of claim 9, wherein the partitioning is performed without decompressing the compressed blocks and comprises:
generating the intervals based at least in part on summary data corresponding to each of the individual compressed blocks and stored separately from the compressed blocks; and
computing interval scores for the individual intervals based on the summary data.

12. The method of claim 11, wherein the intervals are evaluated in an order based on one or both of: respective positions of the individual intervals in the range or the interval scores.

13. The method of claim 9, wherein the processing comprises:
decompressing one or more compressed blocks overlapping at least one of the non-prunable intervals; and
processing the one or more overlapping compressed blocks using a document at a time (DAAT) algorithm

14. The method of claim 9, wherein the evaluating and processing are performed by toggling at least once between two phases until the non-prunable intervals have been processed.

15. The method of claim 14, wherein the at least two phases comprise:
a gathering phase during which at least some of the intervals are evaluated in an order, and during which one or more compressed blocks overlapping at least one evaluated non-prunable interval are stored in a memory buffer until the memory buffer is full; and
a processing phase during which the one or more non-prunable evaluated intervals are processed in another order.

16. A system, comprising:
an information retrieval (IR) engine configured to process a search query, the IR engine comprising:
an interval generation module configured to partition a range of compressed blocks of an inverted index into intervals and to compute interval scores for the individual intervals, individual compressed blocks comprising document identifiers (doc IDs) for documents containing at least one search term of the search query; and
an interval pruning module configured to utilize the interval scores to evaluate the intervals and, based on the evaluation, process a portion of the intervals to identify at least one of the doc IDs that satisfies the search query.

17. The system of claim 16, wherein the information retrieval IR engine further comprises a summary data module configured to:
compute summary data corresponding to individual compressed blocks; and
store the summary data in the inverted index separately from the compressed blocks.

18. The system of claim 17, wherein the interval generation module is further configured to utilize the summary data to partition the range and to compute the interval scores.

19. The system of claim 16, wherein the interval generation module is further configured to isolate, from doc IDs of the compressed blocks, individual doc IDs having a corresponding doc ID term score in a designated percentage of the term scores of the doc IDs of the compressed blocks.

20. The system of claim 19, wherein the interval generation module is further configured to utilize a fancy list of the individual isolated doc IDs to partition the range into the intervals, wherein the intervals comprise a first set of fancy intervals corresponding to the individual isolated doc IDs and a second set of non-fancy intervals not corresponding to the individual isolated doc IDs.
